(19) United States
(12) Patent Application Publication
(10) Pub. No.: US 2014/0022487 A1
(43) Pub. Date: Jan. 23, 2014

(54) LCD DEVICE

(71) Applicants: Jiaqiang Wang, Shenzhen (CN); Shihhsiang Chen, Shenzhen (CN); Guofu Tang, Shenzhen (CN)

(72) Inventors: Jiaqiang Wang, Shenzhen (CN); Shihhsiang Chen, Shenzhen (CN); Guofu Tang, Shenzhen (CN)

(21) Appl. No.: 13/636,377

(22) PCT Filed: Jul. 23, 2012
(86) PCT No.: PCT/CN12/78998

§ 371 Date: Sep. 21, 2012

(30) Foreign Application Priority Data
Jul. 19, 2012 (CN) 201210250298.2

(51) Int. Cl. G02F 1/1333

(52) U.S. Cl. CPC G02F 1/133308
USPC 349/58

(57) ABSTRACT

The present disclosure relates to the field of liquid crystal displays (LCDs), and more particularly to an LCD device. The LCD device includes a front frame, a backplane, and an LCD panel. The LCD panel is arranged between the front frame and the backplane. The front frame is a separate structure and at least includes two front frame units, and the at least two front frame units include a first front frame unit and a second front frame unit. The first front frame unit includes a top wall and a side wall, and the second front frame unit includes a top wall, a side wall, and a bottom wall. The second front frame unit is attached to the LCD device from the side of the LCD device, and an upper surface of the LCD panel and a lower surface of the backplane are clamped by the second front frame unit. The front frame of the present disclosure is a separate structure. The second front frame unit not only includes the top wall and the side wall, but also includes the bottom wall. The bottom wall of the second front frame unit is in contact with the lower surface of the backplane. So the second front frame unit is not slanted. Thus, the compressing force to the LCD panel is improved, and a more safe and reliable LCD device is obtained, which is particularly suitable for the LCD device with narrow frames.

### TECHNICAL FIELD

The present disclosure relates to the field of liquid crystal displays (LCDs), and more particularly to an LCD device.

### BACKGROUND

A typical liquid crystal display (LCD) device generally includes a front frame, an LCD panel, a middle frame, a light guide panel (LGP), and a backplane. As shown in FIG. 1, the LCD panel 2, the middle frame 3, and the LGP 4 are arranged between the from frame I and the backplane 5. The front frame 1 is attached to the backplane 5, and the side wall of the front frame 1 is locked and fixed to the backplane 5. Thus, the LCD panel 2, the middle frame 3, and the LGP 4 are fixed together. As frames of the. LCD device get narrower, fixation of the front frame becomes more and more difficult, and thus the front frame is easy to become slanted. Once slanting, a compressing force applied to the LCD panel is insufficient. Thus, it is urgent to update the structure to ensure that the LCD panel is safely and reliably fixed by the front frame.

### SUMMARY

In view of the above-described problems, the aim of the present disclosure is to provide a liquid crystal display (LCD) device of which an LCD panel is fixed safely and reliably.

A first technical scheme of the present disclosure is that: an LCD device comprises a front frame, a backplane, and an LCD panel. The LCD panel is arranged between the. front frame and the backplane. The front frame is of a separate structure and at least comprises two front frame units which are a first front frame unit and a second front frame unit. The first front frame unit comprises a top wall and a side wall, and the second front frame unit comprises a top wall, a side wall, and a bottom wall. The second front frame unit is attached to the LCD device from the side of the LCD device, and an upper surface of the LCD panel and a lower surface of the backplane are damped by the second front frame unit. The front frame comprises four side frames, the first front frame unit comprises three linked side frames, and the second front frame unit comprises one side frame. The first front frame unit and the second front frame unit are locked and fixed to the backplane via a screw. A width of the bottom wall of the second front frame unit is greater than a width of the top waft The backplane comprises a side wall. The side wall of the first front frame unit and the side wall of the second front frame unit are locked and fixed to the side wall of the backplane via the screw. The bottom wall of the second front frame unit is configured with a clamping structure. The backplane is configured with a light emitting diode (LED) lightbar and a heat radiating aluminum extrusion. The heat radiating aluminum extrusion comprises an elastic clamping arm and, and the heat radiating aluminum extrusion is fixed to the backplane. In addition, the backplane comprises a through hole, the elastic clamping arm extends from the through hole on the backplane and is matched with the clamping structure on the second front frame unit. There are multiple pairs of clamping structures on the second front frame unit and multiple pairs of elastic clamping arms on the heat radiating aluminum extrusion. The LCD device further comprises a middle frame and a light guide panel (LGP). The LGP is arranged in the backplane, and the middle frame is arranged between the LCD panel and the LGP. The middle frame comprises a side wall, and the side wall of the middle frame is vertically aligned with the side wall of the backplane.

A second technical scheme of the present disclosure is that: an LCD device comprises a front frame, a backplane, and an LCD panel. The LCD panel is arranged between the front frame and the backplane. The front frame is of a separate structure and at least comprises two front frame units which are a first front frame unit and a second front frame unit. The first front frame unit comprises a top wall and a side wall, and the second front frame unit comprises a top wall, a side wall, and a bottom wall. The second front frame unit is attached to the LCD device from a side of the LCD device, and an upper surface of the LCD panel and a lower surface of the backplane are clamped by the second front frame unit.

In one example, the front frame comprises four side frames. The first front frame unit comprises three linked side frames, and the second from frame unit comprises one side frame. The first front frame unit and the second front frame unit are locked and fixed to the backplane via a screw. Because of no bottom wall, the first front frame unit can be directly attached on the backplane from top to bottom, and because of only comprising one side frame, the second front frame unit can be conveniently attached to the LCD device from the side of the LCD device.

In one example, the front frame comprises four side frames. The first front frame unit comprises two linked side frames, the second front frame unit comprises two linked side frames. The first front frame unit and the second from frame unit are both locked and fixed to the backplane via a screw. Although it is slightly difficult to assemble, the effect of preventing the front frame from being rolled over is better.

In one example, the first front frame unit and the second front frame unit are of a C-shaped structure. The first front frame unit and the second front frame unit are locked and fixed to the backplane via a screw. Although it is slightly difficult to assemble, the effect of preventing the front frame from being rolled over is better.

In one example, a width of the bottom wall of the second front frame unit is greater than a width of a top wall. Due to the requirement for a trend of narrower frames, the width of the top wall of a front frame should be only further reduced instead of being increased. But, because the bottom wall of the second front frame unit is unrestricted, the greater the width of the bottom wall is, the more it can prevent the front frame from being rolled over.

In one example, the backplane comprises a side wall. The side wall of the first front frame unit and the side wall of the second front frame unit are locked and fixed to the side wall of the backplane via a screw. Using a typical fixing mode, the influence on an entire LCD device, caused by the change of a structural scheme, can be minimized. In addition, because the second front frame unit is not rolled over generally, the second front frame unit can be completely fixed only by locking the screws from the side of the LCD device.

In one example, the backplane comprises a bottom plate. The bottom plate comprises a bulge. Correspondingly, the bottom wall of the second front frame unit comprises a positioning hole. The bulge is fitted into the positioning hole, and then a predetermined position is formed by the second front frame unit and the backplane, which facilitates the subsequent step of being fixed by the screw.

In one example, the bottom wall of the second front frame comprises a clamping structure, and the backplane is configured with an LED lightbar and a heat radiating aluminum extrusion. The heat radiating aluminum extrusion comprises an elastic clamping arm, and the heat radiating aluminum extrusion is fixed to the backplane. The backplane comprises a through hole, and the elastic clamping arm extends from the through hole on the backplane and is matched with the clamping structure on the second front frame unit, which facilitates the subsequent step of being fixed by the screw.

In one example, there are multiple pairs of clamping structures on the second front frame unit and multiple pairs of elastic clamping arms on the heat radiating aluminum extrusion.

In one example, the LCD device further comprises a middle frame and an LGP. The LGP is arranged in the backplane, and the middle frame is arranged between an LCD panel and the LGP and comprises a side wall. The side wall of the middle frame is vertically aligned with the side wall of the backplane. Because the side wall of the middle frame is vertically aligned with the side wall of the backplane, frames of the LCD device are narrowed by a wall thickness of the side wall of the middle frame or the backplane. It is a crucial development direction of narrow frame design.

The present disclosure has the advantages that: the front frame of the LCD device of the present disclosure is of a separate structure and at least comprises two front frame units. The first front frame unit comprises a top wall and a side wall, and the second front frame unit not only comprises a top wall and a side wall, but also comprises a bottom wall. The second front frame unit is attached to the LCD device from the side of the LCD device, and the upper surface of the LCD panel and the lower surface of the backplane are clamped by the second front frame unit. In addition, because the second front frame unit is clamped and attached to the LCD device from the side and the bottom wall of the second front frame unit is in contact with the lower surface of the backplane, the second front frame unit is not rolled over. Thus, the compressing force to the LCD panel is improved, and a more safe and reliable LCD device is obtained, which is particularly suitable for the LCD device with narrow frames.

### BRIEF DESCRIPTION OF FIGURES

FIG. 1 is a sectional view of a typical LCD device;

FIG. 2 is a sectional view of an LCD device of a first example of the present disclosure;

FIG. 3 is a disassembled structure diagram of a front frame of an LCD device of a first example of the present disclosure;

FIG. 4 is a sectional view of an LCD device of a first example of the present disclosure at a positioning hole of a front frame; and disclosure.

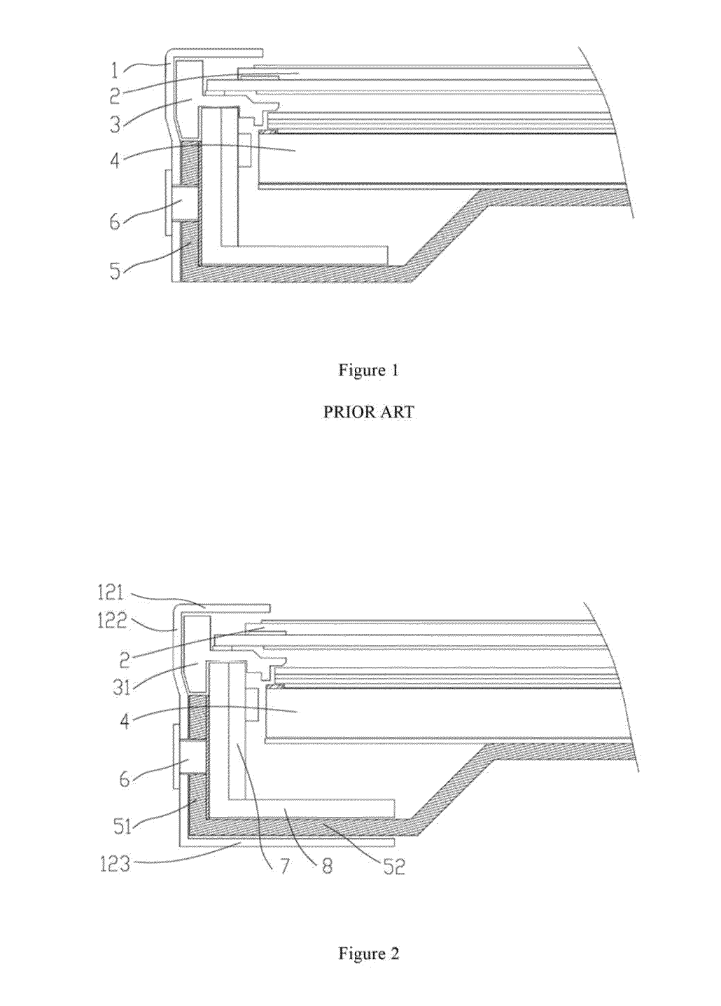

Legends: 1. front frame; 11. first front frame unit; 111. top wall; 112. side wall; 12. second front frame unit; 121. top wall; 122. side wall; 123. bottom wall; 124. positioning hole; 125. clamping structure; 2. LCD panel; 3. middle frame; 31. side wall; 4. LGP; 5. backplane; 21. side wall: 52. bottom plate; 521. bulge; 522. through hole; 6. screw; 7. LED lightbar; 8. heat radiating aluminum extrusion; 81. elastic clamping arm.

### DETAILED DESCRIPTION

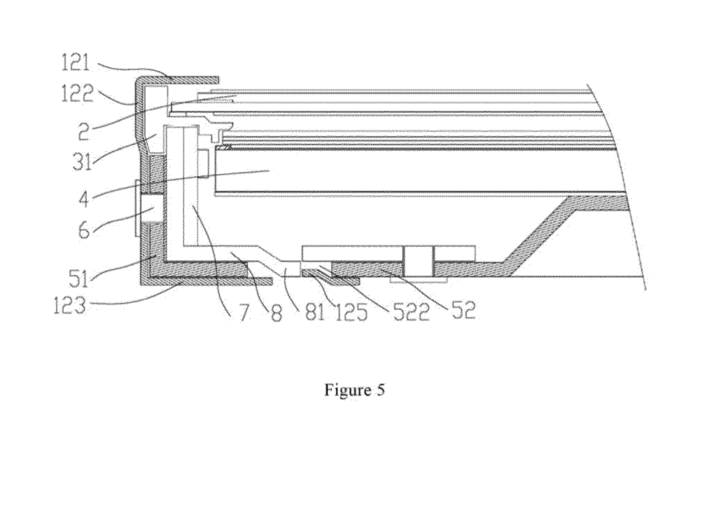

The present disclosure provides a liquid crystal display (LCD) device. FIG. 2 to FIG. 4 show a first example (an exemplary example) of the LCD device of the present disclosure. The LCD device comprises a front frame 1, a backplane, and an LCD panel 2. The LCD panel 2 is arranged between the front frame 1 and the. backplane. The front frame 1 is a separate structure and at least comprises two front frame units, the at least two front frame units comprise a first front frame unit 11 and a second front frame unit 12. The first front frame unit 11 comprises a top wall 111 and a side wall 112, and the second front frame unit 12 comprises a top wall 121, a side wall 122, and a bottom wall 123. The second front frame unit 12 is attached to the LCD device from the side of the LCD device, and an upper surface of the LCD panel 2 and a lower surface of the backplane are clamped by the second front frame unit 12.

The front frame of the LCD device of the present disclosure is a separate structure and at least comprises two front frame units. The first front frame unit 11 comprises the top wall 111 and the side wall 112, and shape of the first front frame unit 11 corresponds to shape of the typical front frame. The second front frame unit 12 not only comprises the top wall 121 and the side wall 122, but also comprises the bottom wall 123. The second front frame unit 12 is attached to the LCD device from the side of the LCD device, and the upper surface of the LCD panel 2 and the lower surface of the backplane are clamped by the second front frame unit 12. In addition, because the second front frame unit 12 is clamped and attached to the LCD device from the side of the LCD device, and the bottom wall 123 of the second front frame unit 12 is in contact with the lower surface of the backplane, the second front frame unit 12 does not slant. Thus, compressing force applied to the LCD panel 2 and to the light guide panel (LGP) 4 is improved, and a more safe and reliable LCD device is obtained, which is particularly suitable for the LCD device with narrow frames.

In the example, the LCD device further comprises a middle frame 3 and an LOP 4. The LGP 4 is arranged in the backplane, and the middle frame 3 is arranged between the LCD panel 2 and the LOP 4 and comprises a side wall 31. The side wall 31 of the middle frame 3 is vertically aligned with the side wall 51 of the backplane. Thus, the frames of the LCD device are narrowed by a wall thickness of the side wall of the middle frame or the backplane. It is a crucial development direction for narrower frame design.

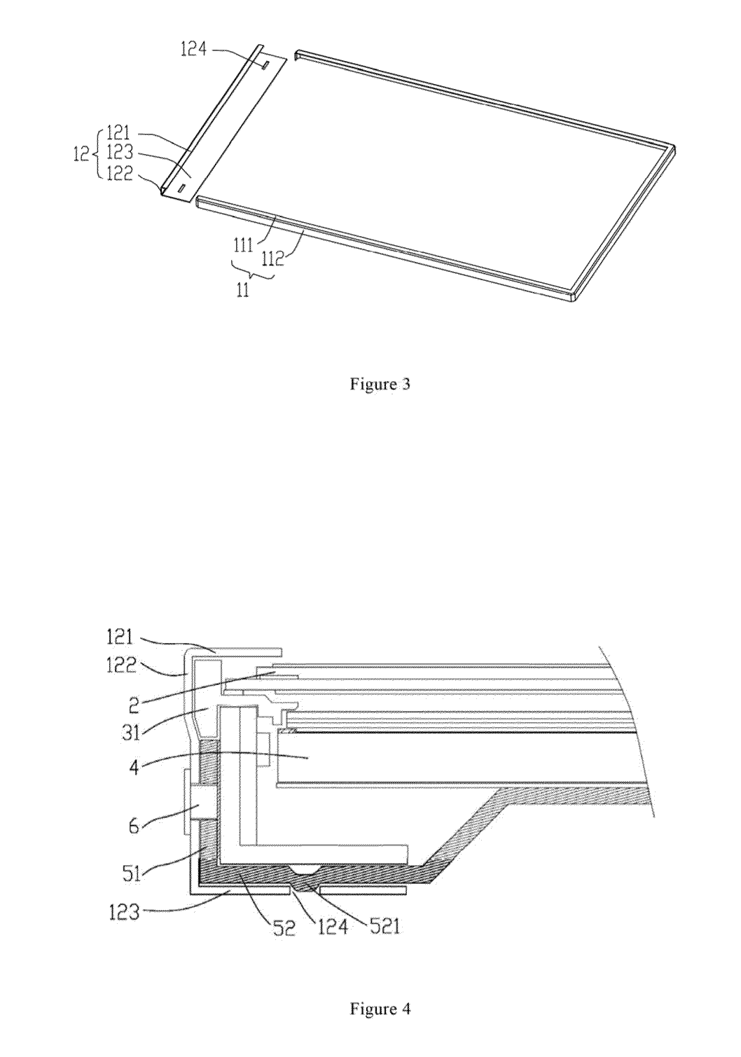

In the example, as shown in FIG. 3, the front frame comprises four side frames. The first front frame unit 11 comprises three linked side frames, and the second front frame unit 12 comprises one side frame. The first front frame unit 11 and the second front frame unit 12 are locked and fixed to the backplane via a screw. Because there is no bottom wall arranged. on the first frame unit 11, the first front frame unit 11 can be directly attached to the backplane from top to bottom, and because the second frame unit 12 only comprises one side frame, the second front frame unit 12 can be conveniently attached to an LCD device from the side of the LCD device.

In the example, the backplane comprises a bottom plate 52. The bottom plate 52 comprises a bulge 521. Correspondingly, the bottom wall 123 of the second front frame unit 12 comprises a positioning hole 124. The bulge 521 is fitted into the positioning hole 124, and then a predetermined position is formed by the second front frame unit 12 and the backplane, which facilitates the subsequent step of being fixed by screws. Because there are two pairs of positioning holes 124 and bulges 521 and the positioning holes 124 and the bulges 521 are arranged separately, two ends of the second front frame unit 12 can be effectively pre-positioned.

In the example, the backplane comprises the side wall 51. The side wall of the first front frame unit 11 and the side wall of the second front frame unit 12 are locked and fixed to the side wall 51 of the backplane via the screw 6. A change of a structural scheme maybe influence the entire LCD device, and the influence on the entire LCD device can be minimized when using a typical fixing mode. In addition, because the second front frame unit 12 cannot be slanted generally, the second front frame unit 12 can be completely fixed only by locking the screws from the side of the LCD device.

In the example, a width of the bottom wall 123 of the second front frame unit is greater than a width of the top wall 121. Due to the progression towards narrower frames, the width of the top wall 121 of the front frame should be only further reduced instead of being increased. But, because the bottom wall 123 of the second front frame unit is unrestricted, the greater the width of the bottom wall 123 is the more it can prevent the front frame from being rolled over.

In the aforementioned example, the front frame can also he in other bent and separate shape. For example, the first front frame unit comprises two linked side frames and the second front frame unit comprises two linked side frames. Alternatively, the first front frame unit and the second front frame unit are a C-shaped structure, and the front frame unit of the C-shaped structure comprises one complete side frame and two incomplete side frames, and a complete and closed front frame is formed by connecting face to face the two C-shaped structure front frame units. The first front frame unit and the second front frame unit are locked and fixed to the backplane via the screw. Because the side frame of the second front frame unit is more than one side frame, it is slightly difficult to be attached to the LCD device and the effectivity is low, but the effect of preventing the front frame from being slanted is improved.

In the aforementioned example, the number of the front frame units can also be three, and two front frame units comprise the bottom walls used to prevent the front frame being slanted. The number of the front frame units can also be four, and all these four front frame units comprise the bottom walls and are locked and fixed to the side wall of the backplane via the screw on the side.

FIG. 5 shows as second example of the LCD device of the present disclosure. Difference between the first example and the second example is that: the structure of the predetermined position between the second front frame unit 12 and the backplane of the second example is different from that of the first example. The bottom wall 123 of the second front frame unit comprises a clamping structure 125. The backplane is configured with a light emitting diode (LED) lightbar 7 and a heat radiating aluminum extrusion 8. The heat radiating aluminum extrusion 8 comprises an elastic clamping arm 81, and the heat radiating aluminum extrusion 8 is fixed to the backplane via to screw. The backplane comprises to through hole 522. The elastic clamping arm 81 extends from the through hole 511 of the backplane and matched with the clamping structure 125 on the second front frame unit. There are multiple pairs of clamping structures 125 on the second front frame unit and multiple pairs of elastic clamping arms 81 on the heat radiating aluminum extrusion. in the example, the number is two pairs. Thus, the second front frame unit 12 can be preferably fixed to the predetermined position of the backplane, which facilitates the subsequent step of fixing the screw. Rest of the structures and advantages are the same as in the first example, so the details are not provided here.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

We claim:

1. A liquid crystal display (LCD) device, comprising:
a front frame;
a backplane comprising a side wall;
an LCD panel arranged between the front frame and the backplane;
a light guide panel (LGP) arranged in the backplane; and
a middle frame arranged between the LCD panel and the LGP, and wherein the middle frame comprises a side wall, and the side wall of the middle frame is vertically aligned with the side wall of the backplane;
wherein the front frame is a separate structure and at least comprises two from frame units, the at least two front frame units comprise a first front frame unit and a second front frame unit, wherein the first front frame unit comprises a top wall and a side wall, the second front frame unit comprises a top wall, a side wall, and a bottom wall;
wherein the second front frame unit is attached to the LCD device from a side of the LCD device, and an upper surface of the LCD panel and to lower surface of the backplane are clamped by the second front frame unit, wherein the front frame comprises four side frames; the first front frame unit comprises three linked side frames, and the second front frame unit comprises one side frame, wherein the first front frame unit and the second front frame unit are locked and fixed to the backplane via a screw, and a width of the bottom wall of the second front frame unit is greater than a width of the top wall;
wherein the side wall of the first front frame unit and the side wall of the second front frame unit are locked and fixed to the side wall of the backplane via the screw, and the bottom wall of the second front frame unit comprises a clamping structure; and
wherein the backplane is configured with a light emitting diode (LED) lightbar and a heat radiating aluminum extrusion, wherein the beat radiating aluminum extrusion comprises an elastic clamping arm, and the heat radiating aluminum extrusion is fixed to the backplane, wherein the backplane comprises a through hole, and the elastic clamping arm extends from the through hole on the backplane and is matched with the clamping structure on the second front frame unit, and wherein the number of clamping structures on the second front frame unit and the number of elastic clamping arms on the heat radiating aluminum extrusion are multiple pairs.

2. A liquid crystal display (LCD) device, comprising:
a front frame;
a backplane comprising a side wall; and
an LCD panel arranged between the front frame and the backplane;
wherein the front frame is a separate structure and at least comprises two front frame units, the two front frame units comprising a first front frame unit and a second front frame unit, the first front frame unit comprises a top wall and a side wall, and the second front frame unit comprises a top wall, a side wall, and a bottom wall, wherein the second front frame unit is attached to the LCD device from a side of the LCD device, and an upper surface of the LCD panel and a lower surface of the backplane are clamped by the second front frame unit.

3. The LCD device of claim 2, wherein the front frame comprises four side frames, the first front frame unit comprises three linked side frames, and the second front frame unit comprises one side frame, the first front frame unit and the second front frame unit are locked and fixed to the backplane via a screw.

4. The LCD device of claim 3, wherein the backplane comprises a side wall, the side wall of the first front frame unit and the side wall of the second front frame unit are locked and fixed to the side wall of the backplane via the screw.

5. The LCD device of claim 2, wherein the front frame comprises four side frames, the first front frame unit comprises two linked side frames, and the second front frame unit comprises two linked side frame, and the first front frame unit and the second front frame unit are locked and fixed to the backplane via a screw.

6. The LCD device of claim 5, wherein the backplane comprises a side wall, the side wall of the first front frame unit and the side wall of the second front frame unit are locked and fixed to the side wall of the backplane via the screw.

7. The LCD device of claim 2, wherein the first front frame unit and the second front frame unit are of a C-shaped structure and locked and fixed to the backplane via a screw.

8. The LCD device of claim 7, wherein the backplane comprises a side wall, the side wall of the first front frame unit and the side wall of the second front frame unit are locked and fixed to the side wall of the backplane via the screw.

9. The LCD device of claim 2 wherein a width of the bottom wall of the second front frame unit is greater than a width of the top wall.

10. The LCD device of claim 2, wherein the backplane comprise a bottom plate, the bottom plate comprises a bulge, the bottom wall of the second front frame unit comprises a positioning hole, and the bulge is fitted into the positioning hole to form a predetermined position by the second front frame unit and the backplane.

11. The LCD device of claim 2, wherein the bottom wall of the second front frame comprises a clamping structure, and the backplane is configured with a light emitting diode (LED) lightbar and a heat radiating aluminum extrusion, the heat radiating aluminum extrusion comprises an elastic clamping arm, and the heat radiating aluminum extrusion is fixed to the backplane, the backplane comprises a through hole, and the elastic clamping arm extends from the through hole on the backplane and is matched with the clamping structure on the second front frame unit.

12. The LCD device of claim 11, wherein there are multiple pairs of clamping structures on the second front frame unit and multiple pairs of elastic clamping arms on the heat radiating aluminum extrusion.

13. The LCD device of claim 2, wherein the LCD device further comprises a middle frame and a light guide panel (LGP), the LGP is arranged in the backplane, and the middle frame is arranged between the LCD panel and the LGP, the middle frame comprises a side wall, and the side wall of the middle frame is vertically aligned with the side wall of the backplane.
